(19) United States
(12) Patent Application Publication
(10) Pub. No.: US 2025/0316188 A1
(43) Pub. Date: Oct. 9, 2025

(54) APPARATUS FOR DEVELOPING AND TESTING DEVICES AND METHODS FOR EMBOLIZING A BLOOD VESSEL

(71) Applicant: THE JOHNS HOPKINS UNIVERSITY, Baltimore, MD (US)

(72) Inventors: Prateek C. GOWDA, Baltimore, MD (US); Clifford R. Weiss, Baltimore, MD (US)

(21) Appl. No.: 18/873,095

(22) PCT Filed: Jun. 8, 2023
(86) PCT No.: PCT/US2023/024828

§ 371 Date: Dec. 9, 2024

Related U.S. Application Data
(60) Provisional application No. 63/351,041, filed on Jun. 10, 2022.

(51) Int. Cl. G09B 23/30

(52) U.S. Cl. CPC G09B 23/303

(57) ABSTRACT

An apparatus has a body defining an interior flow path. The interior flow path includes a portion of an artificial artery and at least one branch from the artificial artery. The body includes, in fluid communication with the interior flow path, at least one inlet and a main outlet. Each branch of the at least one branch from the artificial artery includes a respective branch outlet. The body includes a plurality of outwardly extending conduits in fluid communication with, and spaced along, the interior flow path.

### CROSS-REFERENCE TO RELATED APPLICATION

This application claims priority to and the benefit of the filing date of U.S. Provisional Patent Application No. 63/351,041, filed Jun. 10, 2022, the entirety of which is hereby incorporated by reference herein.

### FIELD

This application relates to systems and methods for developing and testing devices and methods for embolizing blood vessels.

### BACKGROUND

A major subsegment of intervention radiology (IR) practice is transarterial embolization (TAE) procedures, in which a physician advances a catheter percutaneously to a target artery site and employs devices to occlude blood flow. TAE is a first-line treatment option for a variety of solid cancers, including hepatocellular carcinoma (HCC), and represents a significant or growing portion of treatments for benign prostatic hyperplasia, uterine fibroids, osteoarthritis, and obesity. TAE can also be used in traumatic injuries to reduce hemorrhage in ruptured arteries. Overall, the number of percutaneous embolization procedures is growing substantially, increasing in volume by 125% since 2005. This growth has been largely attributed to improved patient outcomes from these types of procedures and has been fueled by the advancement of novel embolization devices that improve efficacy and safety.

The development of new endovascular technologies has so far relied on animal studies to validate efficacy before clinical trials. The current innovation pathway is limited, as most technology validation is conducted in animals, usually swine models, which can be both lengthy and financially limiting for researchers. More importantly, since procedures are conducted with fluoroscopic guidance alone, it is difficult to assess the mechanisms of action of new technologies as it is not feasible to measure local hemodynamic changes of devices intra-procedurally in animals or patients. Benchtop flow models are limited in their ability to control for and measure flow and pressure changes in and around the target vasculature. Physiologically relevant measurements of flow and pressure are crucial towards optimal device development.

There is a need for a multi-parametric in vitro model to better understand how transarterial embolization procedures affect the local vascular environment, through the measurement of local pressure, flow, and imaging changes.

Systems and methods for developing and testing devices and methods for embolization of a vessel such as an artery are therefore desirable.

### SUMMARY

Disclosed herein, in one aspect, is an apparatus having a body defining an interior flow path. The interior flow path includes a portion of an artificial artery and at least one branch from the artificial artery. The body includes, in fluid communication with the interior flow path, at least one inlet and a main outlet. Each branch of the at least one branch from the artificial artery includes a respective branch outlet. The body includes a plurality of outwardly extending conduits in fluid communication with, and spaced along, the interior flow path.

In one aspect, a method of using the apparatus includes introducing or otherwise establishing flow of a fluid into the at least one inlet of the body: injecting an embolic agent into the flow path at an embolization site: and measuring flow through at least one of the main outlet or the respective branch outlet for each branch of the at least one branch.

Additional advantages of the disclosed system and method will be set forth in part in the description which follows, and in part will be understood from the description, or may be learned by practice of the disclosed system and method. The advantages of the disclosed system and method will be realized and attained by means of the elements and combinations particularly pointed out in the appended claims. It is to be understood that both the foregoing general description and the following detailed description are exemplary and explanatory only and are not restrictive of the invention as claimed.

### BRIEF DESCRIPTION OF THE DRAWINGS

The accompanying drawings, which are incorporated in and constitute a part of this specification, illustrate several embodiments of the disclosed apparatus, system, and method and together with the description, serve to explain the principles of the disclosed apparatus, system, and method.

FIG. 1 is a schematic diagram showing an exemplary system for testing devices and methods for embolizing blood vessels as disclosed herein.

FIG. 2 illustrates a body of the system of FIG. 1.

FIG. 3 illustrates a body of another exemplary system as disclosed herein.

FIG. 4 illustrates a system including the body as in FIG. 3.

FIG. 5 is a block diagram showing an operating environment comprising a computing device for use with the systems as disclosed herein.

FIGS. 6A-6B illustrate modeling steps and design of hepatic vascular phantom. FIG. 6A shows a wireframe shape was first composed on CAD and cross sections were added according to literature reported values. Cross sections were lofted along the artery path and shelled to produce a smooth vasculature. Strut supports, tube barbs, and female Luer adapters were appended to the initial design to integrate within the flow loop and enable pressure sensor placement. FIG. 6B shows the final printed vasculature in clear, acrylic-simulating material, with male Luer caps covering pressure ports. The celiac artery was the source of fluid inflow while other branches were outflows. The major arteries of the celiac axis were captured, including the splenic, gastroduodenal, left hepatic, right hepatic, and right hepatic branches.

FIG. 7 illustrates a flow loop for the hepatic vascular model. The system provides a testbed for hepatic arterial interventions. The operator inserts equipment through the sheath just proximal to the celiac artery inlet, mimicking the approach made by interventional radiologists. The operator may then advance the device of study into the target site. This diagram depicts a procedure in a branch of the right hepatic artery, where an example placement of pressure sensors is illustrated. Flow meters are measuring bulk flow across both right hepatic branches. The procedure can be visualized directly on the light board or indirectly through the display from the top view video camera. Food-dye may be injected as a surrogate for contrast agent, which provides visualization of changes in flow through the system during the procedure. The system is circulated by the combination pulsatile and continuous pump system.

FIGS. 8A-8D illustrate image processing steps for digital subtraction angiography simulation. FIG. 8A shows a bolus of 1 mL food dye is injected through a catheter that is placed just distally to a bifurcation. The flow valve at the outflow in this vessel is almost closed, such that there is only 15 mL/min flow. The dye is visualized slightly in this image. FIG. 8B shows that as part of the processing step, a series of video before dye injection is recorded and averaged to produce a single image of background. FIG. 8C shows an image corresponding to an entire video file recorded that is subtracted by the background average to produce a digitally subtracted video. In this case, the frame depicted in A is subtracted by B. The image shows high food dye density distal to the catheter injection, but also reflux of the dye into the adjacent branch. The red box is drawn to show the area of analysis for plot D. FIG. 8D shows a depiction of the relative intensity signal across all frames for the digitally subtracted video. The reduction in intensity is associated with the dye bolus injection. After bolus injection, gradual dye washout is observed as intensity returns to baseline. Systolic heart beats are observed (blue arrows) during dye clearing.

FIGS. 9A-9C show input patient profiles. Pressure was measured into the system at the celiac artery and flow through a branch of the right hepatic artery for a variety of simulated patient hemodynamic conditions. FIG. 9A shows a healthy adult with a blood pressure of 119/66 mmHg and heart rate of 65 beats per minute (bpm), and FIG. 9B shows an elderly adult with aortic regurgitation, 142/61 mmHg and 75 bpm. FIG. 9C shows a patient in cardiogenic shock, 79/48 mmHg and 120 bpm.

FIGS. 10A-10G show hemodynamic changes associated with the placement of a 3 mm×8 cm helical Concerto detachable coil system (Medtronic plc, Dublin, Ireland) in a branch of the right hepatic artery. FIG. 10A shows a 2.4-Fr microcatheter that is advanced to the target embolization site over a guidewire. FIG. 10B shows the coil system positioned in the intraluminal space. FIG. 10C shows the coil deployed and the catheter removed. FIGS. 10D and 10F show plots of the baseline pressure and flow data during the panel of FIG. 10A. respectively. FIGS. 10E and 10G show plots of the steady state pressure and flow measured after the placement of the coil from the panel of FIG. 10C. In FIGS. 10D and 10E, the pressure is measured at a point distally to the coil (1), proximally to the coil, but within the same branch (2), proximally to the closest proximal bifurcation (3), and in the branch directly adjacent to the target coiled branch (4). There was an increase in pressures measured proximally to the coil, proximal to the bifurcation, and in the adjacent branch. The pressure measured distally to the coil decreased substantially to a negative value. In FIGS. 10F and 10G, flow meters are placed at the outflow of the target coil branch and the next adjacent branch. After the deployment of the coil, there was an incomplete occlusion of the target branch, resulting in reduced, but not zero, flow. The adjacent branch flow concomitantly increased after deployment.

### DETAILED DESCRIPTION

The disclosed system and method may be understood more readily by reference to the following detailed description of particular embodiments and the examples included therein and to the Figures and their previous and following description.

It is to be understood that the terminology used herein is for the purpose of describing particular embodiments only and is not intended to limit the scope of the present invention which will be limited only by the appended claims.

It must be noted that as used herein and in the appended claims, the singular forms “a,” “an,” and “the” include plural references unless the context clearly dictates otherwise. Thus, for example, reference to “a sensor” includes one or more of such sensors, and so forth.

“Optional” or “optionally” means that the subsequently described event, circumstance, or material may or may not occur or be present, and that the description includes instances where the event, circumstance, or material occurs or is present and instances where it does not occur or is not present.

Ranges may be expressed herein as from “about” one particular value, and/or to “about” another particular value. When such a range is expressed, also specifically contemplated and considered disclosed is the range from the one particular value and/or to the other particular value unless the context specifically indicates otherwise. Similarly, when values are expressed as approximations, by use of the antecedent “about,” it will be understood that the particular value forms another, specifically contemplated embodiment that should be considered disclosed unless the context specifically indicates otherwise. It will be further understood that the endpoints of each of the ranges are significant both in relation to the other endpoint, and independently of the other endpoint unless the context specifically indicates otherwise. Finally, it should be understood that all of the individual values and sub-ranges of values contained within an explicitly disclosed range are also specifically contemplated and should be considered disclosed unless the context specifically indicates otherwise. The foregoing applies regardless of whether in particular cases some or all of these embodiments are explicitly disclosed.

Optionally, in some aspects, when values or characteristics are approximated by use of the antecedents “about,” “substantially,” or “generally,” it is contemplated that values within up to 15%, up to 10%, up to 5%, or up to 1% (above or below) of the particularly stated value or characteristic can be included within the scope of those aspects.

Unless defined otherwise, all technical and scientific terms used herein have the same meanings as commonly understood by one of skill in the art to which the disclosed apparatus, system, and method belong. Although any apparatus, systems, and methods and materials similar or equivalent to those described herein can be used in the practice or testing of the present apparatus, system, and method, the particularly useful methods, devices, systems, and materials are as described.

Throughout the description and claims of this specification, the word “comprise” and variations of the word, such as “comprising” and “comprises,” means “including but not limited to,” and is not intended to exclude, for example, other additives, components, integers or steps. In particular, in methods stated as comprising one or more steps or operations it is specifically contemplated that each step comprises what is listed (unless that step includes a limiting term such as “consisting of”), meaning that each step is not intended to exclude, for example, other additives, components, integers or steps that are not listed in the step. Unless otherwise stated, in the following description and claims, the terms “comprise” or “comprising” also encompass aspects of “consists of,” “consisting of,” “consists essentially of,” and “consisting essentially of.”

As used herein, when “a processor” or “at least one processor” are disclosed as performing certain steps or actions, it should be understood that such disclosure is intended to include aspects in which a single processor performs said steps or actions in any logical order, aspects in which a plurality of processors apply parallel processing to perform said steps or actions, or portions thereof, and aspects in which a plurality of processors sequentially perform said steps or actions, or portions thereof.

As used herein, unless context dictates otherwise, in describing a blood vessel or artificial blood vessel, or placement within a blood vessel or artificial blood vessel, “distal” refers to an end of a blood vessel positioned away from, or representative of what would be positioned away from, a heart, and “proximal” refers to an end of a blood vessel positioned toward, or representative of what would be positioned toward, the heart.

Disclosed herein is a benchtop vascular model that can be used to test or trial key pressure, flow, and/or imaging data. In various aspects, the benchtop vascular model can provide a way to understand mechanism of action of many interventional radiology (IR) devices, procedures, and techniques.

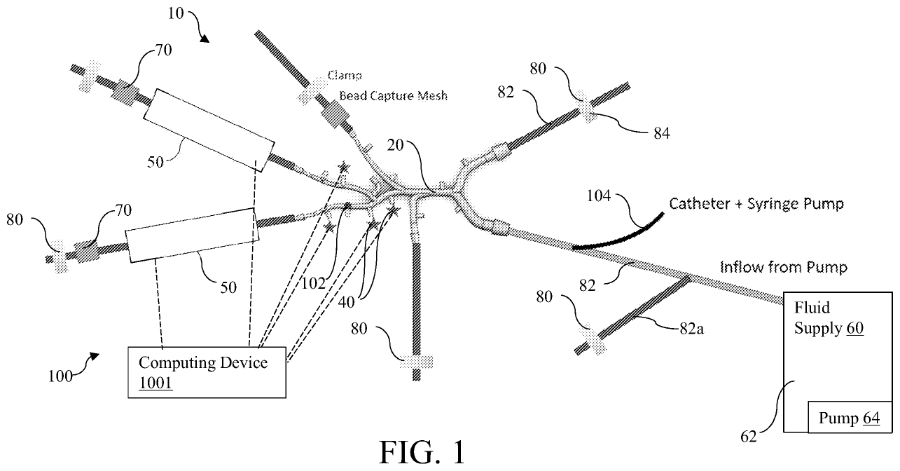

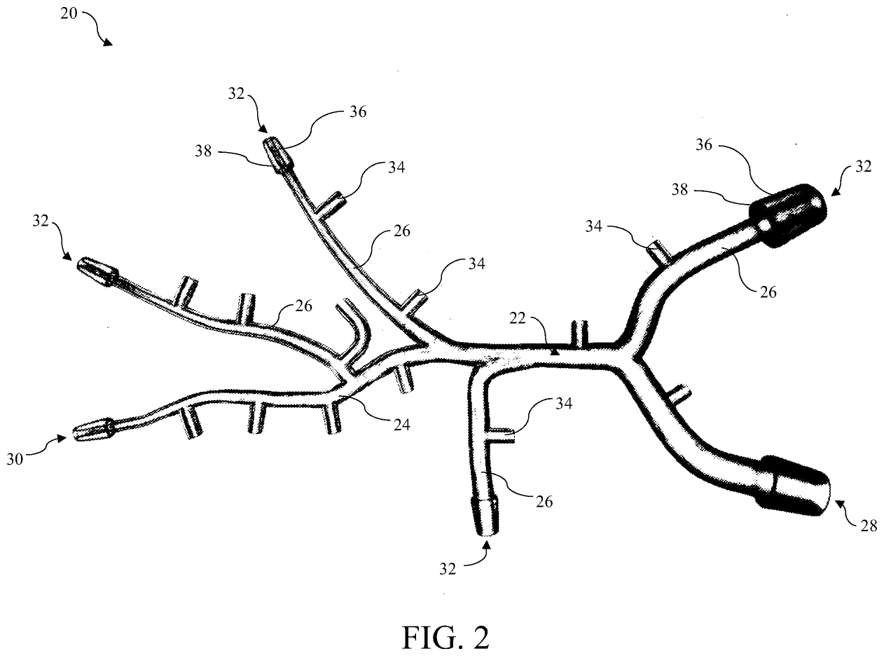

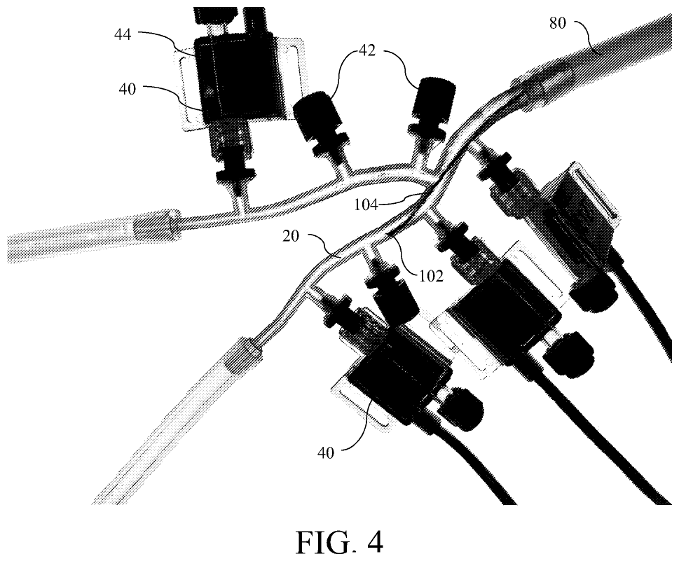

Disclosed herein and with reference to FIGS. 1-4 are embodiments of a system 10 for developing and testing devices and methods for embolizing a blood vessel such as an artery. The system 10 can comprise geometry and structure representative of an artery. That is, the system 10 can comprise structure corresponding to an artificial artery or portion thereof. The system 10 can further comprise equipment (e.g., sensors) for measuring effectiveness of devices and systems for embolizing an artery.

The system 10 can comprise a body 20 defining an interior flow path 22. The interior flow path 20 can comprise a portion of an artificial artery 24 and at least one branch 26 from the artificial artery. The body 20 can comprise, in fluid communication with the interior flow path 22, at least one inlet 28 and a main outlet 30. The main outlet 30 can be in fluid communication with the artificial artery 24. Each branch 26 of the at least one branch from the artificial artery can comprise a respective branch outlet 32.

The body 20 can comprise a plurality of outwardly extending conduits 34 in fluid communication with, and spaced along, the interior flow path 22. For example, the outwardly extending conduits 34 can permit inspection of properties within the interior flow path 22. The outwardly extending conduits 34 can provide fluid communication with the interior flow path 22. For example, one or more of the outwardly extending conduits 34 can be in fluid communication with a pressure sensor 44. In some aspects, the apparatus 20 can comprise, coupled to each outwardly extending conduit 34 of the plurality of outwardly extending conduits, one of: a respective plug 42; or a respective sensor 40 (e.g., a pressure sensor). In exemplary aspects, at least one conduit can be coupled to a plug 42, while at least one other conduit can be coupled to a sensor 40. In further aspects, the sensors 40 can include one or more of: temperature sensors, particle counting sensors (e.g., coulter counters or cell counters), chemical sensors, flow sensors, or electrical impedance sensors.

In some aspects, the outwardly extending conduits 34 can be spaced so that at least one is positioned before and after each bifurcation (e.g., a branch 26 diverging from the artificial artery 24). In further aspects, a plurality of outwardly extending conduits 34 can be positioned between bifurcations. For example, three outwardly extending conduits 34 can be included between bifurcations, with the outwardly extending conduits provided at proximal, distal, and intermediate positions. The plurality of outwardly extending conduits 34 can permit modularity, allowing for various sensor placement locations, depending on the application.

In optional some aspects, the plurality of outwardly extending conduits 34 can extend from the interior flow path 22 perpendicularly or generally perpendicularly to the interior flow path 22. In this way, effects of fluid velocity through the interior flow path 22 on pressure readings can be minimized, as well as to minimize added turbulence of the interior flow path by the outwardly extending conduits 34. Optionally, one or more of the outwardly extending conduits 34 can comprise a curved profile to permit perpendicular intersection with the interior flow path 22 while positioning an opposed coupling end for coupling to a sensor 40 or a plug 42. In further aspects, the outwardly extending conduits 34 can extend from the interior flow path 22 at any angle. In still further aspects, it is contemplated that one or more of the outwardly extending conduits 34 can have a complex curvature in which different portions or sections of the outwardly extending conduit have varying or different radii of curvature.

In exemplary aspects, the outwardly extending conduits 34 can be tubular (e.g., optionally, having hollow, cylindrical or generally cylindrical profiles with annular cross sections).

In optional aspects, the artificial artery 24 can have dimensions representative of a celiac axis. For example, the artificial artery 24 can have inner dimensions (e.g., diameters) along the interior flow path 20 that are consistent with a celiac axis. Thus, in exemplary aspects, the artificial artery 24 and the branches 26 can have inner dimensions that decrease moving therealong in a direction away from the inlet(s) 28. In further aspects, the artificial artery 24 can have dimensions representative of any other artery including, but not limited to: a hepatic artery (e.g., for modeling liver cancer embolization as described herein); a splenic artery (e.g., for modeling treatment of splenic rupture/trauma); a uterine artery (e.g., for modeling treatment of uterine fibroid embolization); prostatic arteries (e.g., for modeling treatment of benign prostatic hyperplasia treatment): gastric artery (e.g., for modeling treatment of bariatric embolization); genicular artery (e.g., for modeling treatment of osteoid arthritis embolization treatment); or abnormal vasculature types (e.g., for modeling treatment of example tumor vasculature such as liver, brain, uterus, soft tissue).

The body 20 can define a respective tube fitting 36 at each of the at least one inlet 28, the main outlet 30, and the respective branch outlet in fluid communication with each branch of the at least one branch from the artificial artery. The tube fitting(s) 36 can optionally comprise barbs 38.

In various optional aspects, the body 20 can be 3D printed using conventional equipment. In this way, the body 20 can be customized for a particular profile. Still further, the body 20 can omit any seams that could develop leaks or could interfere with flow through the interior flow path. In various aspects, the body 20 can be formed as a unitary, monolithic component.

In some aspects, the apparatus 10 can comprise a flow sensor 50 in fluid communication with the main outlet 30 and the respective branch outlet 32 for each branch 26 from the at least one branch from the artificial artery 24. In these aspects, it is contemplated that the flow sensor 50 can be configured to measure flow through the main outlet 30 of the artificial artery 24, providing an indication of changes to flow as the artificial artery is embolized as further disclosed herein.

In some optional aspects, the body 20 can be transparent or translucent. For example, at least a portion, or an entirety of the body 20 can be transparent or translucent. In this way, a position of a catheter inserted therein can easily be seen by a clinician.

The apparatus 10 can further comprise a fluid supply 60 in fluid communication with the at least one inlet 28. Optionally, the fluid supply 60 can comprise a dye, wherein the dye is configured to emulate angiographic imaging. The fluid supply 60 can comprise a vessel containing a fluid 62 (e.g., dye) therein. In some optional aspects, the fluid supply 60 can comprise a pump 64 that is configured to apply pressure to provide the fluid 62 to the at least one inlet. In some aspects, the pump 64 can produce physiologically relevant blood flows. For example, the pump can be configured to pulse to generate pressures consistent with actual blood pressure within an individual.

In some aspects, the at least one branch 26 of the body 20 can consist of a single branch. In some aspects, the at least one branch 26 of the body 20 can consist of two branches. In some aspects, the at least one branch 26 of the body 20 can consist of three branches. In other aspects. the body 20 can comprise three or more branches 26.

Optionally, the apparatus 10 can have only a single inlet 28. In further aspects, the apparatus 10 can comprise two inlets 28. For example, a first inlet can be in fluid communication with the fluid supply 60, and a second inlet can be configured to (and used to) receive a catheter for injecting an embolic agent, as further disclosed herein.

The apparatus 10 can further comprise a filter 70 (e.g., a mesh) that is configured to capture embolic agent. In exemplary aspects, embolic agents can have dimensions (e.g., diameters) on the order of 50-600 microns, depending on the application. Accordingly, in some aspects, the mesh can have 45 micron×45 micron square openings. However, it is contemplated that other mesh sizes can be used, depending on the type of embolic being used (considering that the openings should be smaller than the dimensions of the embolic agent). It is contemplated that the filter 70 can be in fluid communication with the outlet of a branch. Said branch can be upstream of a desired embolization site. In this way, the filter 70 can be configured to capture embolic agent that overflows from the desired embolization site. In various aspects, a respective filter 70 can be in fluid communication with each branch upstream of the desired embolization site. A filter 70 can further be in fluid communication with the main outlet 30.

Captured embolic agent can be measured. For example, the filter (and any tubing or housing associated therewith) can be massed before and after delivery of embolic agent, and the mass change can correspond to the amount of embolic agent captured by the filter. In further aspects, particles can be suspended in fluid (e.g., water) and counted via a cell counter.

In various other aspects, the artificial artery 24 and the branches 26 can all taper to a cross sectional dimension that captures the embolic agent, as is consistent with an actual vascular system.

A fluid inhibiting device 80 can be configured to obstruct flow through one or more inlets and outlets. For example, tubing 82 can be in fluid communication with each inlet and outlet of the body 20, and a respective clamp 84 can be configured to restrict flow through the respective tubing 82. In further aspects, the fluid inhibiting device 80 can be a valve that blocks flow therethrough.

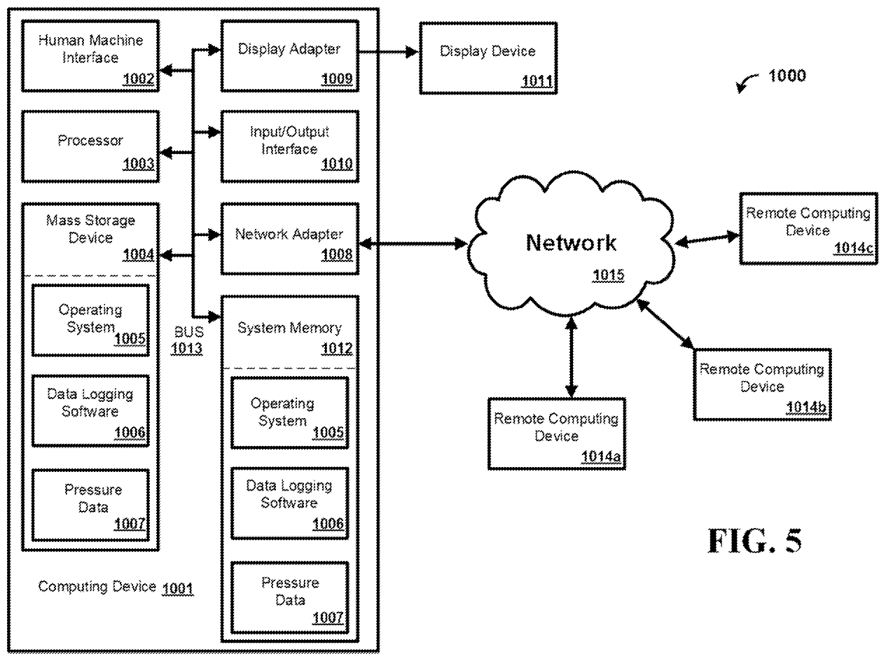

A system 100 can comprise an apparatus 10 and a computing device 1001 (FIG. 5) in operative communication with the apparatus. For example, each sensor 40 of the apparatus 10 can be in operative communication with the computing device 1001. The computing device 1001 can be configured to store and log data associated with the sensors 40. Optionally, noise filters can be used to smooth out data (e.g., pressure data).

Digital subtraction angiograph (DSA) techniques can be used to visualize the blood vessels.

### Method of Using Apparatus

In some aspects, a method of using the apparatus 10 can comprise flowing a fluid 62 of the fluid supply 60 into the at least one inlet 28 of the body 20. An embolic agent can be injected into the flow path at an embolization site 102. Flow through at least one of the main outlet 30 and/or the respective branch outlet 32 for each branch of the at least one branch can be measured. For example, the flow sensor(s) 50 can measure flow through the main outlet 30 of the artificial artery 24, indicating changes to flow as the artificial artery is embolized. Increased flow through the branch outlet(s) 32 can be indicative of redirected flow from the main outlet to the branch outlets. Decreased flow through the branch outlet(s) 32 can be indicative of embolic agent entering and embolizing the branch 26. For example, in operation, embolization of a target branch can result in decreased flow, leading to redirection of flow into adjacent branches.

At least one pressure can be measured at one or more of the outwardly extending conduits 34 of the plurality of outwardly extending conduits. The measured pressures can be indicative of embolization progress. For example, in some aspects, pressures at multiple locations can be compared with each other over the course of an experiment. These comparisons can be especially important in understanding the mechanism of action of embolization devices and physician techniques.

In some aspects, the fluid 62 can comprise a dye that is configured to emulate angiographic imaging. In exemplary aspects, the fluid 62 can comprise food coloring (for example, and without limitation black, dark blue, dark green, or dark red food coloring). However, it is contemplated that the system can use any dye that can be visualized by a camera through a light board.

In some aspects the embolic agent flowing through at least one branch that is upstream of the embolization site 102 can be collected (e.g., in a filter 70 such as a mesh). For example, the filter 70 can be positioned at a branch of the at least one branch that is upstream of the embolization site. A filter 70 can further be positioned downstream of the embolization site 102. For example, a respective filter can be in fluid communication with the main outlet 30 and each branch outlet 32 downstream of the embolization site 102.

In various aspects in which the body 20 comprises a first inlet and a second inlet, the fluid 62 can be flowed into the first inlet. Prior to injecting the embolic agent into the flow path at the embolization site 102, the catheter 104 can be inserted into the second inlet, and the embolic agent can be injected through the catheter and delivered to the embolization site 102. In further aspects, tubing 82 in fluid communication with the inlet 28 can be opened (e.g., sliced) to receive the catheter 104 (as illustrated in FIG. 1), and the catheter can be inserted therein and through the inlet 28.

Additional tubing (e.g., tubing 82a) can be coupled to tubing in fluid communication with the body 20 to simulate other portions of a model vasculature, and tubing can be opened or closed (e.g., clamped) to provide pressure changes or simulate various events.

In various aspects, embolization can be performed with the system 100 using particles, coils, glue, or other closure devices.

In still further aspects, the system 100 can be used for other vascular interventions. For example, the system 100 can be used to develop or practice treatments to address aneurysm, stenosis, external impingement, tortuosity, or anastomotic stricture. For example, flow diverter devices, or flow opening devices (e.g., angioplasty) can be tested and practiced. The system 100 can provide flow, pressure, and/or imaging data from any simulated procedure.

### Computing Device

FIG. 5 shows an operating environment 1000 including an exemplary configuration of a computing device 1001 for use with the system 10 (FIG. 1).

The computing device 1001 may comprise one or more processors 1003, a system memory 1012, and a bus 1013 that couples various components of the computing device 1001 including the one or more processors 1003 to the system memory 1012. In the case of multiple processors 1003, the computing device 1001 may utilize parallel computing.

The bus 1013 may comprise one or more of several possible types of bus structures, such as a memory bus, memory controller, a peripheral bus, an accelerated graphics port, and a processor or local bus using any of a variety of bus architectures.

The computing device 1001 may operate on and/or comprise a variety of computer readable media (e.g., non-transitory). Computer readable media may be any available media that is accessible by the computing device 1001 and comprises, non-transitory, volatile and/or non-volatile media, removable and non-removable media. The system memory 1012 has computer readable media in the form of volatile memory, such as random access memory (RAM), and/or non-volatile memory, such as read only memory (ROM). The system memory 1012 may store data such as pressure data 1007 and/or program modules such as operating system 1005 and threshold comparison software 1006 that are accessible to and/or are operated on by the one or more processors 1003.

The computing device 1001 may also comprise other removable/non-removable, volatile/non-volatile computer storage media. The mass storage device 1004 may provide non-volatile storage of computer code, computer readable instructions, data structures, program modules, and other data for the computing device 1001. The mass storage device 1004 may be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any number of program modules may be stored on the mass storage device 1004. An operating system 1005 and threshold comparison software 1006 may be stored on the mass storage device 1004. One or more of the operating system 1005 and threshold comparison software 1006 (or some combination thereof) may comprise program modules and the threshold comparison software 1006. The pressure data 1007 may also be stored on the mass storage device 1004. The pressure data 1007 may be stored in any of one or more databases known in the art. The databases may be centralized or distributed across multiple locations within the network 1015.

A user may enter commands and information into the computing device 1001 using an input device. Such input devices comprise, but are not limited to, a joystick, a touchscreen display, a keyboard, a pointing device (e.g., a computer mouse, remote control), a microphone, a scanner, tactile input devices such as gloves, and other body coverings, motion sensor, speech recognition, and the like. These and other input devices may be connected to the one or more processors 1003 using a human machine interface 1002 that is coupled to the bus 1013, but may be connected by other interface and bus structures, such as a parallel port, game port, an IEEE 1394 Port (also known as a Firewire port), a serial port, network adapter 1008, and/or a universal serial bus (USB).

A display device 1011 may also be connected to the bus 1013 using an interface, such as a display adapter 1009. It is contemplated that the computing device 1001 may have more than one display adapter 1009 and the computing device 1001 may have more than one display device 1011. A display device 1011 may be a monitor, an LCD (Liquid Crystal Display), light emitting diode (LED) display, television, smart lens, smart glass, and/or a projector. In addition to the display device 1011, other output peripheral devices may comprise components such as speakers (not shown) and a printer (not shown) which may be connected to the computing device 1001 using Input/Output Interface 1010. Any step and/or result of the methods may be output (or caused to be output) in any form to an output device. Such output may be any form of visual representation, including, but not limited to, textual, graphical, animation, audio, tactile, and the like. The display 1011 and computing device 1001 may be part of one device, or separate devices.

The computing device 1001 may operate in a networked environment using logical connections to one or more remote computing devices 1014a,b,c. A remote computing device 1014a,b,c may be a personal computer, computing station (e.g., workstation), portable computer (e.g., laptop, mobile phone, tablet device), smart device (e.g., smartphone, smart watch, activity tracker, smart apparel, smart accessory), security and/or monitoring device, a server, a router, a network computer, a peer device, edge device or other common network node, and so on. Logical connections between the computing device 1001 and a remote computing device 1014a,b,c may be made using a network 1015, such as a local area network (LAN) and/or a general wide area network (WAN), or a Cloud-based network. Such network connections may be through a network adapter 1008. A network adapter 1008 may be implemented in both wired and wireless environments. Such networking environments are conventional and commonplace in dwellings, offices, enterprise-wide computer networks, intranets, and the Internet. It is contemplated that the remote computing devices 1014a,b,c can optionally have some or all of the components disclosed as being part of computing device 1001. In various further aspects, it is contemplated that some or all aspects of data processing described herein can be performed via cloud computing on one or more servers or other remote computing devices. Accordingly, at least a portion of the system 1000 can be configured with internet connectivity.

### Exemplary Embodiment

A vascular model of the celiac axis and its major branches was developed according to anatomically accurate dimensions. Table 1 shows design criteria of the vascular model. The model was designed to be clear and planar to enable placement on a light board for radiation-free image analysis. FIG. 1(A) delineates the design steps of the vascular phantom. A wireframe was first created using SolidWorks CAD software (Dassault Systèmes, Vélizy-villacoublay, France). The arterial vessel path was determined using de-identified computed tomography angiography scans and reported hepatic vasculature models, and was approved by a board-certified interventional radiologist with 15 years of experience [13]. Artery lumen cross-sections were placed along the path according to average dimensions reported in literature [20]. A 3D model was produced by lofting the cross-sections using the vascular path as the centerline, creating a smooth solid vascular lumen. The vascular walls were created using the shell feature to add 0.5 millimeters of material along the circumference of the vasculature and produce a hollow lumen. Barbs were appended to all vascular ends to best fit standard-sized silicon tubing in the vascular flow loop. Pressure ports were placed at multiple proximal and distal branch points in the vascular model. This was accomplished by extruding a cylinder perpendicular to the wireframe model that was then attached with a female Luer connector part using the assembly tool.

The CAD model was exported to an STL file and prepared for printing using Meshmixer (Autodesk, Inc, San Rafael, CA). Software automatically added support material around the vascular model and the print-ready file was sent to an Objet 260 Connex 3 material jetting printer (Stratasys Ltd, Rehovot, Israel). The model was printed in clear acrylic-simulating material (VeroClear Stratasys) and support structures were printed in an opaque water-soluble material (SUP706b, Stratasys). Following print, the body was rinsed in a water bath to remove external support structures. Support material within the lumen of the model was removed manually with a combination of pipe cleaners and a hand-held faucet jet. Once most of the bulk support material was removed, the model was placed in a sonic bath with a basic, 10 pH solution for 5 minutes to dislodge remaining material. This was followed by another water rinse and repeated as necessary to remove any lingering support material. To ensure optical clarity as visualized through a light board, the model was then polished with a series of fine grit sand paper, producing the final post-processed print.

### Flow Loop Assembly

The vascular phantom was connected to a hydraulic flow loop with multiple components including a pressure source, adjustable flow resistors, mesh filters, pressure transducers, and flow sensors. All equipment implemented in the flow loop are itemized in Table 2.

A combination of a pulsatile pump and brushless DC motor pump system was used to mimic physiologic flow conditions in the hydraulic system. The pulsatile pump (PD-1100, BDC Laboratories, Wheat Ridge, CO) features an adjustable stroke volume and pulse rate. The brushless DC motor pump was inserted in parallel with the pulsatile system. One-way valves were placed distally to both pumps. The DC motor pump allowed for the application of a constant pressure source into the system and produced constant low-noise flow and was controllable with an adjustable 24V DC power supply. The pulsatile pump system was adjustable for stroke rate and volume, representing systolic pressure in the system, while the DC motor pump controlled for diastolic blood pressure. One-way valves prevented backflow into either pump over the course of the cardiac cycle. In such a way, physiologically similar cardiac cycle waveforms could be reproduced in the vascular model.

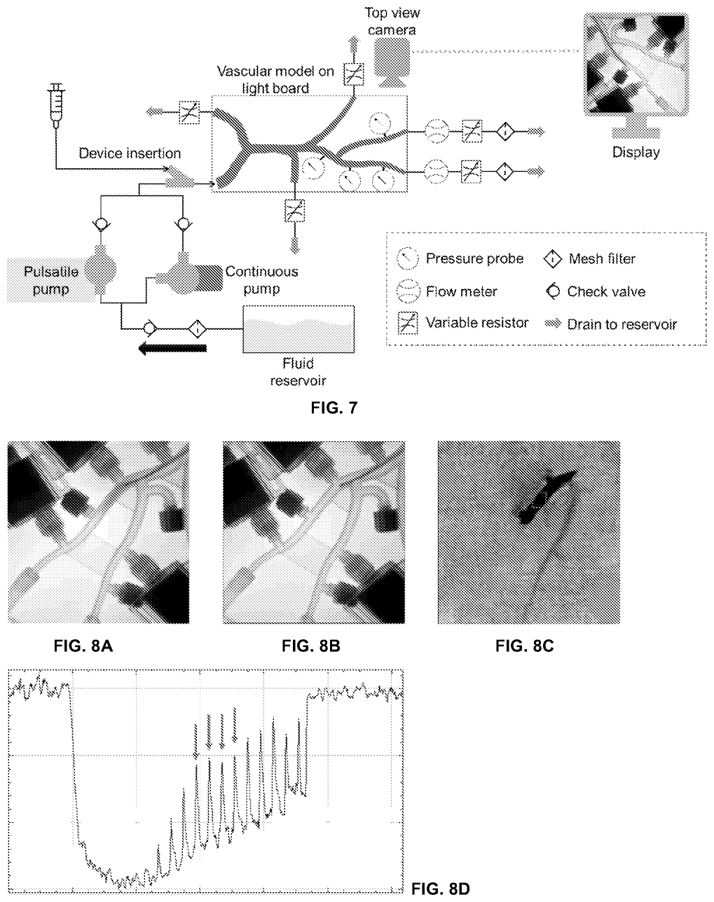

Standard-sized silicone tubing and tubing adaptors were used to connect the components of the flow loop (FIG. 7). In-line needle-type flow valves were attached to branches of the vascular phantom for fine control of flow resistance. The reservoir tank was placed underneath the vascular phantom, and fluid was pumped vertically from the bottom of the tank to prevent the introduction of air into the system.

### Pressure and Flow Sensors

The vascular phantom is constructed with special consideration for modularity of pressure sensor placement, so that many vascular locations may be alternatively probed with a single phantom. Pressure sensors (BDC Laboratories) were connected to the branches of interest via Luer-Lock prior to each experiment, while unused ports were closed with caps. Probes measured pressure in real time with sampling rate set on an accompanying software package.

Ultrasonic clamp-on flow sensors (FD-XS8, Keyence Corporation, Osaka, Japan) were placed on the outflow tubing to measure bulk flow rate through the branch. Ultrasonic sensors are preferred in this application compared to a rotary-style meter as ultrasonic sensors do not introduce resistance to fluid flow. The clamp-on feature also allows for placement on different tubing portions to probe flow and contributes to the modularity of the model across many experimental parameters. Flow measurements were outputted to an analog 4 to 20 mA current signal across a 0 to 8000 mL/min flow range. Data was converted to a 1-5V voltage signal with a 250 Ohm shunt resister and read through a USB data acquisition module and logger (DI-1100, DATAQ Instruments Inc, Akron, OH). Both pressure and flow could be monitored in real time during the course of an experiment.

### Imaging Capture and Analysis

Angiography was simulated in the model by injecting a black food-coloring agent (McCormick & Co, Hunt Valley, MD) in the clear vascular phantom. Images were acquired with a stationary custom webcam produced in-house, although a readily available mobile camera is also amenable to use. Raw video was processed on ImageJ FIJI (National Institutes of Health, Bethesda, MD) to produce digitally subtracted images representative of digital subtraction angiography (FIG. 8). For processing, images were first converted to grey scale. A segment of images at the start of the video, when no food-coloring was injected into the system, was selected to serve as the background signal. Background signal images were averaged and digitally subtracted from each image of the total video stack, producing a digitally subtracted image. Absorption data was quantified by drawing a region of interest and plotting Z-axis profile.

### Characteristic Patient Profiles

To evaluate the capabilities of the model to simulate patient-relevant flow conditions, three standard patient profiles were trialed: healthy adult, aortic regurgitation, and shock. Data for average blood pressure and heart rate for these types of patients were inputted into the model according to literature reported values. Output pressure and flow values were measured and plotted for a sample of 5 seconds.

### Coil Embolization Trial

To highlight the application of the vascular model to measure hemodynamic changes associated with a transarterial embolization procedure, placing a coil in a branch of the right hepatic artery was trialed. A 2.4-Fr DraKon microcatheter (Guerbet, Villepinte, France) was advanced to a branch of the right hepatic artery over a 0.018-inch guidewire. The guidewire was removed and exchanged with a 3 mm×8 cm helical Concerto detachable coil system (Medtronic plc, Dublin, Ireland). The coil was positioned within the artery lumen between two pressure measurement sites, such that there was a distal and proximal pressure sensor within the branch. As well, a pressure sensor was placed on an adjacent branch of the closest bifurcation, and a pressure sensor was placed proximal to a bifurcation. Flow meters were positioned to measure live flow rates in the target branch vessel and the adjacent branch vessel. Once adequate positioning was achieved, the coil was detached and the catheter was retracted. Real-time pressure and flow measurements were made and recorded throughout the procedure.

### Results

The model was constructed to measure multiple hemodynamic parameters, visualize procedures separate from fluoroscopy, and to be versatile for many experimental parameters.

### Vascular Phantom

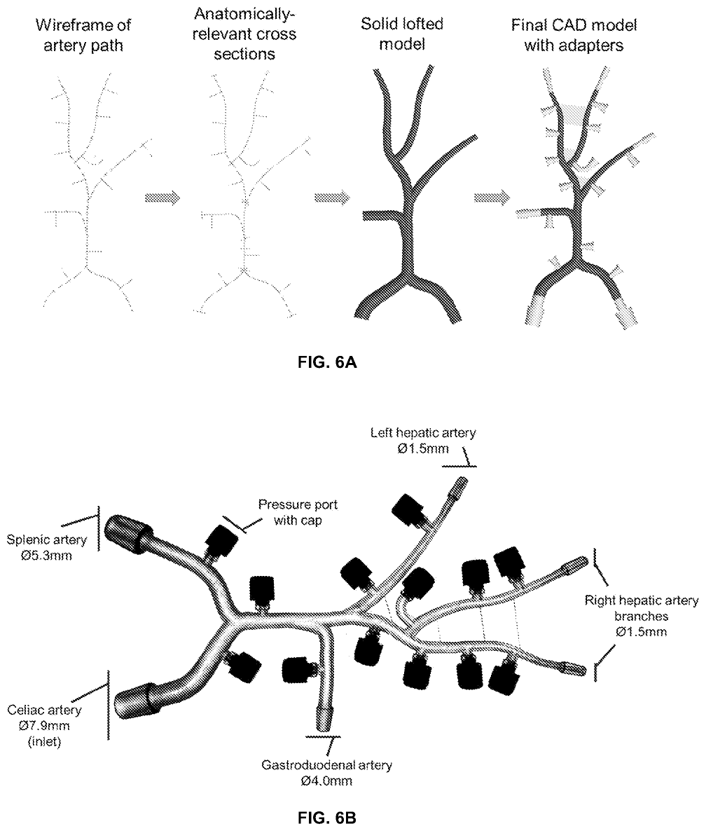

The vascular phantom was designed and printed successfully in rigid, clear material. The total print time was about 4 hours, with 30 minutes to 1 hour required for post processing. The print costed ˜$30 in materials. When placed on a light board, interior lumen details were clearly visible (FIG. 6). Attachment of barbs to silicone tubing and placement of Luer caps or pressure sensors on the pressure ports were quick and without leaks once water was perfused through the system.

### Image Analysis

A 2.4-Fr Guerbet DraKon microcatheter was successfully advanced to a branch of the right hepatic artery, just distal to a bifurcation. A bolus of 1 mL food dye was injected under video recording as the flow valve at the outflow in the residing vessel was almost closed, such that there was a measured 15 mL/min flow. The images were successfully imported onto ImageJ software. A digitally subtracted image isolating only the food dye injection was successfully produced and a Z-axis plot depicted clear signal visualization against background intensity signal. FIG. 8 depicts the image processing steps during this bolus injection.

### Patient Profiles

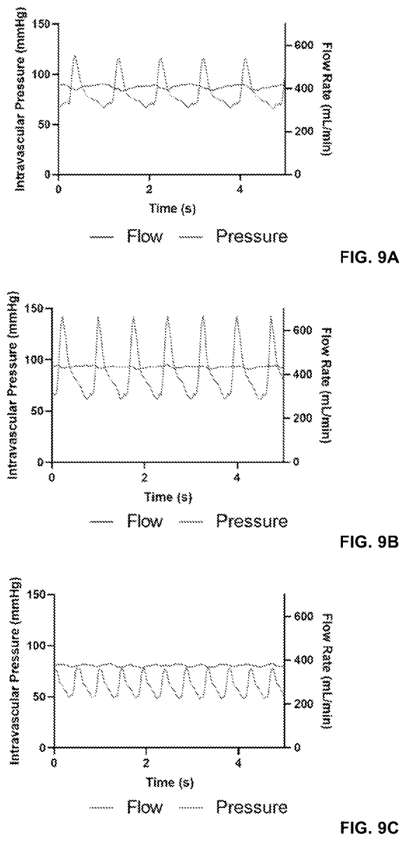

Patient profiles were successfully inputted and replicated in the model, according to the targeted hemodynamic parameters for a healthy adult, an adult with aortic regurgitation, and a patient in cardiogenic shock (FIG. 9). Waveforms were achieved through a combination of vessel resistance modulation through flow valves, and control of the input power signal to the motor system. Pressures and heart rates of 119/66 mmHg and 65 beats per minute (bpm) were recorded for the healthy adult, 142/61 mmHg and 75 bpm for the aortic regurgitation case, and 79/48 mmHg and 120 bpm for the cardiogenic shock case. The flow rate through a branch of the right hepatic artery was measured for each of these cases: 407.9±8.4 mL/min, 434.5 mL/min±4.52, and 376.1±4.4 mL/min for the healthy, aortic regurgitation, and shock cases, respectively.

### Coil Embolization

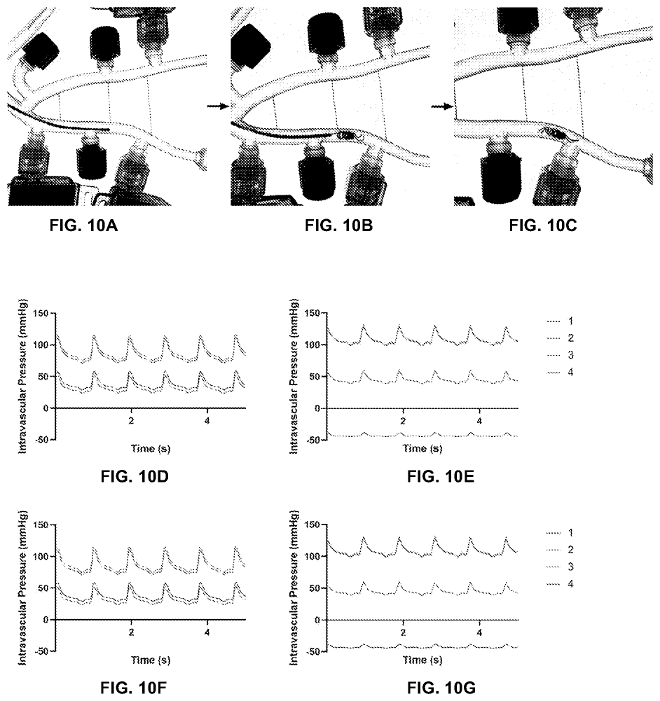

A sample transarterial embolization procedure was trialed with the placement of a 3 mm×8 cm helical Concerto detachable coil system in a branch of the right hepatic artery. The pressure and flow sensors were placed according to FIG. 7. FIG. 10 depicts the coil procedure and the associated changes in pressure and flow. Flow in the target vessel was reduced from a mean of 427.4±6.8 mL/min to 96.7±3.8 mL/min (77% reduction), while in the adjacent vessel there was an increase from a mean of 405.6±7.0 to 509.9±0.97 (26% increase). Between pre and post pressure measurements, there was an increase in pressure directly proximal to the coil in the same branch (111.3 mmHg systolic pressure to 128.7 mmHg. 15.6% increase), proximal to a bifurcation (115.8 to 131.3 mmHg, 13.4% increase), and in the adjacent branch (52.1 to 60.2 mmHg, 15.5% increase). Just distally to the coil there was decrease in pressure (59.4 to-38.1, 164% reduction).

### Discussion

In this paper, the construction and highlight the use of a multi-parametric benchtop vascular model to simulate transarterial embolization procedures are disclosed. This anatomically and physiologically accurate model provides the ability to measure hemodynamic metrics that are essential towards assessing the efficacy of new endovascular technologies. This model furthermore allows for high-throughput and low-cost testing as compared to the existing alternative of animal testing. In vitro hepatic vascular phantoms have been described in the literature, but previously described models do not measure simultaneous gauge pressures and flows at multiple branch locations or allow for an angiographic-imitative visualization. Studies in computational and vascular models of transarterial embolization therapies have demonstrated that intra-arterial hemodynamic changes may represent key metrics towards procedure efficacy and may aid in physician decision making [11, 17, 21].

3D printing in transparent material was used to provide a means of flow visualization without fluoroscopy, improving access for researchers with limited budgets and without relationships to academic radiology departments. 3D printing was also inexpensive, with a full model print costing ˜$30 in material. A single model furthermore provided the opportunity for multiple experiment permutations, as the vessel of interests could be modified by changing the placement of pressure probes and flow meters. The method illustrated in FIG. 6 also allows for rapid prototyping of new vessels of interest. Other embolization targets of interest, such as the cerebral arteries, prostatic artery, etc. may also be produced in this way. Average vessel dimensions and baseline hemodynamic parameters may be obtained from literature and bypasses the need to access patient specific information. The remaining equipment necessary for the flow loop, described in Table 2, are commercially available components. Input flow, controlled by the pulsatile pump system and brushless motor pump, is highly adjustable. Tubing connections are easily adjusted for new vascular designs.

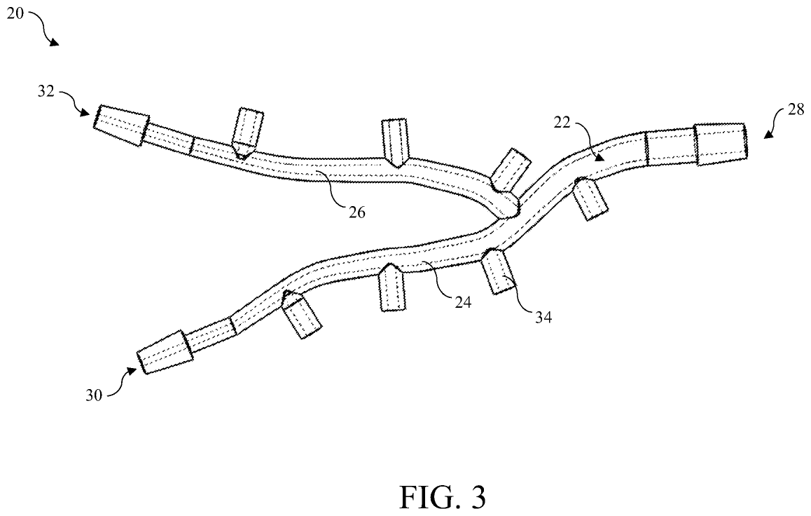

Production of clinically accurate digitally subtracted video was a key design criterion in the model and permits quantitative comparisons of imaging with measured pressure and flow data. The model notably simulates realistic contrast washout, which is one of the primary angiographic features that guide physician decision making during the procedure. FIGS. 3C and 3D highlight the visualization and quantification of what is known as the “beats-of-stasis” measurement used in transarterial embolization therapy. Interventional radiologists measure the number of heart beats needed for a bolus of contrast agent to wash out. This is used as one of the primary clinical endpoints for determining adequate flow cessation. The model discernably captured such a measurement both visually and through area under the curve measurements, which show spiking during systole and corresponding reduction in food dye. Further insight can be gained in future experimentation through correlating physician determined beats-of-stasis with hemodynamic measurements that are otherwise not able to be measured in patient procedures.

The ability to modify blood pressure and flow conditions across physiologically relevant patient profiles are shown, including a healthy patient, aortic regurgitation, and shock. The model could reliably simulate physiologically accurate pressure waveforms in these conditions. This is especially important considering the relevance of the pulse waveform to the beats-of-stasis metric and in the goal of measuring changes in pressure and flow. The measured pressure and flow data correlates with literature reported magnitudes as well. It was observed that a total flow rate of ˜1200 mL/min perfusing through all hepatic artery branches, similar to the upper limit of values in the literature 11. Similarly, mean arterial pressure in the hepatic artery has been reported to range from 60-95 mmHg, which is reduced from what is typically measured at the level of the aorta. All pressure and flow factors were easily fine-tuned through a combination of pump power settings and modulation of flow valves across each of the outlet vessels.

Finally, the utility of the model is shown in simulating a coil embolization and measuring multiple simultaneous pressure and flow changes. Advancement to the target site followed common clinical procedure. A guidewire was required to navigate the catheter and the coil was deployed as directed in the device's technical manual. Comparing flow and pressure data pre-and post-placement, an incomplete occlusion of flow using a single coil was demonstrated. This was evident in the partial reduction of the target branch from a mean flow of 427 mL/min to 97 mL/min, a reduction of 77%. This was associated with flow increase in the adjacent branch by 26%. Similarly, blood pressure increased at points measured proximal to the coil, or in the adjacent vessel, and decreased distal to the coil. These findings have been demonstrated in part across studies of vessel occlusion in animals and humans. Borowski et al. demonstrate a partial increase in proximal pressure during occlusion from transarterial embolization therapy in the hepatic artery5. Rose et al. measure a reduction in pressure in the hepatic artery when measured distally to an occlusion balloon [17]. Schwartz et al. recapitulate the increase in adjacent vessel flow and a reduction in distal pressure in a partially occluded coronary artery in an open-chest dog model [19]. The measurement of all these parameters simultaneously is not possible in patients or animals due to the invasive nature of measurement modalities. This combination of existing data validates those observed in a similar occlusion procedure in the model.

In conclusion, the vascular model presented in this example is anatomically and physiologically relevant and allows for simultaneous, multiparametric pressure, flow, and imaging measurements. Such a model is relevant to the further understanding of the effect of interventional radiology procedures on local hemodynamics and may serve as a valuable testbed for the study of transarterial embolization technologies.

TABLE 1
Vascular Model Design Parameters
Design Criteria

Anatomically relevant vascular phantom
Multi-location pressure monitoring
Non-invasive flow monitoring
Clear vasculature for procedure visualization without fluoroscopy
Production of digital subtraction angiography for assessment
and direct comparison to measured hemodynamic values
Physiologically similar hemodynamic values
Rapid experimental throughput

TABLE 2
Components of Vascular Model

| | | |
|---|---|---|
| Equipment | Manufacturer | Function |

Vascular Phantom

| | | |
|---|---|---|
| 3D Printed Model | In-house | Test bed for arterial |
| | | interventions |
| Programmable Syringe | New Era Pump Systems | Controlled injection of food |
| Pump | | dye for visualization |
| Product Development Kit | Merit Medical | Assortment of Luer |
| | | connectors, syringes, and |
| | | tubing to simulate |
| | | interventional radiology |
| | | procedures |

Flow Loop

| | | |
|---|---|---|
| PD-1100 Pulsatile Pump + | BDC Laboratories | Set systolic blood pressure, |
| Controller and data | | heart rate, and waveform |
| acquisition hardware, | | |
| Software | | |
| 24 V DC Brushless Motor | Multiple suppliers | Set diastolic blood pressure |
| Pump | | into vascular phantom |
| Voltage Speed Controller | Multiple suppliers | Controls motor speed to |
| | | adjust diastolic pressure |
| Assortment of 1/8″, 1/4″, | Cole-Palmer | Connects equipment in the |
| 3/16″, 1/2″, 3/4″ silicone | | flow loop via barbs |
| tubing | | |
| Assortment of Y-Channel, | Multiple suppliers | Splicing tubing, joining |
| Barb Reducers, Elbow | | tubing of different sizes. |
| Connectors, and Tubing | | Cuffs maintain seal at |
| Cuffs for 1/8″, 1/4″, 3/16″, | | connection points |
| 1/2″, 3/4″ sizes | | |

Flow and Pressure Sensors

| | | |
|---|---|---|
| Pressure Transducers + | BDC Laboratories | Pressure sensors connect via |
| Controller and DAQ | | male Luer connection to |
| Hardware, Software | | model. Acquisition hardware |
| | | and software allows for |
| | | multiple simultaneous live |
| | | measurements |
| Ultrasonic Flow Sensors | Keyence Corporation | Non-invasive flow |
| | | measurements, clamp on |
| | | tubing to assess flow rate of |
| | | vasculature of interest |
| Flow sensor data acquisition | DATAQ Instruments | Data acquisition hardware |
| module and software | | and software reads 1-5 V |
| | | signal from flow sensors and |
| | | displays values from |
| | | multiple simultaneous flow |
| | | sensors. |

Imaging

| | | |
|---|---|---|
| Video camera | In-house | Capture of interventions and |
| | | food dye for post-procedural |
| | | analysis. |
| Fiji image processing | National Institutes of Health | Image processing, digital |
| package | | subtraction, and analysis |

### Exemplary Aspects

In view of the described products, systems, and methods and variations thereof, herein below are described certain more particularly described aspects of the invention. These particularly recited aspects should not however be interpreted to have any limiting effect on any different claims containing different or more general teachings described herein, or that the “particular” aspects are somehow limited in some way other than the inherent meanings of the language literally used therein.

Aspect 1: An apparatus comprising:
a body defining an interior flow path, wherein the interior flow path comprises a portion of an artificial artery and at least one branch from the artificial artery, wherein the body comprises, in fluid communication with the interior flow path, at least one inlet and a main outlet, wherein each branch of the at least one branch from the artificial artery comprises a respective branch outlet, wherein the body comprises a plurality of outwardly extending conduits in fluid communication with, and spaced along, the interior flow path.

Aspect 2: The apparatus of aspect 1, wherein the artificial artery has dimensions representative of a celiac axis.

Aspect 3: The apparatus of aspect 1 or aspect 2, wherein the body defines a respective tube fitting at each of the at least one inlet, the main outlet, and the respective branch outlet for each branch of the at least one branch from the artificial artery.

Aspect 4: The apparatus of aspect 3, wherein the respective tube fitting comprises a barb.

Aspect 5: The apparatus of any one of the preceding aspects, wherein the body is 3D printed.

Aspect 6: The apparatus of any one of the preceding aspects, further comprising, coupled to each outwardly extending conduit of the plurality of outwardly extending conduits, one of:
a respective plug; or
a respective sensor.

Aspect 7: The apparatus of aspect 6, wherein each respective sensor is a pressure sensor.

Aspect 8: The apparatus of any one of the preceding aspects, further comprising a flow sensor in fluid communication with the main outlet and the respective branch outlet for each branch of the at least one branch from the artificial artery.

Aspect 9: The apparatus of any one of the preceding aspects, wherein the body is transparent or translucent.

Aspect 10: The apparatus of any one of the preceding aspects. further comprising a fluid supply in fluid communication with the at least one inlet.

Aspect 11: The apparatus of any one of the preceding aspects, wherein the at least one branch from the artificial artery comprises three branches.

Aspect 12: The apparatus of any one of the preceding aspects, wherein the at least one inlet consists of a single inlet.

Aspect 13: The apparatus of any one of the preceding aspects, wherein the at least one inlet comprises two inlets.

Aspect 14: The apparatus of any one of the preceding aspects, wherein the plurality of outwardly extending conduits extend perpendicularly or generally perpendicularly to the interior flow path.

Aspect 15: A method of using the apparatus as in any one of the preceding aspects, the method comprising:
flowing a fluid into the at least one inlet of the body;
injecting an embolic agent into the flow path at an embolization site; and
measuring flow through at least one of:
   the main outlet; or
   the respective branch outlet for each branch of the at least one branch.

Aspect 16: The method of aspect 15, further comprising measuring at least one pressure at at least one outwardly extending conduit of the plurality of outwardly extending conduits.

Aspect 17: The method of aspect 15 or aspect 16, wherein the fluid comprises a dye, wherein the dye is configured to emulate angiographic imaging.

Aspect 18: The method of any one of aspects 15-17, further comprising collecting, at a branch of the at least one branch that is upstream of the embolization site, the embolic agent.

Aspect 19: The method of aspect 18, wherein catching the embolic agent comprises catching the embolic agent in a mesh.

Aspect 20: The method of any one of aspects 15-19, wherein the at least one inlet comprises a first inlet and a second inlet, wherein flowing the fluid into the at least one inlet comprises flowing the fluid into the first inlet, the method comprising, prior to injecting the embolic agent into the flow path at the embolization site, inserting a catheter into the second inlet, wherein injecting the embolic agent into the flow path at the embolization site comprises injecting the embolic agent through the catheter.

Those skilled in the art will recognize, or be able to ascertain using no more than routine experimentation, many equivalents to the specific embodiments of the method and compositions described herein. Such equivalents are intended to be encompassed by the following claims.

The following references are incorporated by reference herein in their respective entireties.

### REFERENCES

1. Aghilinejad, A., F. Amlani, K. S. King, and N. M. Pahlevan. Dynamic Effects of Aortic Arch Stiffening on Pulsatile Energy Transmission to Cerebral Vasculature as A Determinant of Brain-Heart Coupling. Scientific reports 10:8784, 2020.
2. Aramburu. J., R. Antón, J. Fukamizu, D. Nozawa, M. Takahashi, K. Ozaki, J. C. Ramos, B. Sangro, J. I. Bilbao, K. Tomita, T. Matsumoto, and T. Hasebe. In Vitro Model for Simulating Drug Delivery during Balloon-Occluded Transarterial Chemoembolization. Biology (Basel, Switzerland) 10:1341, 2021.
3. Bagla, S., R. Piechowiak, T. Hartman, J. Orlando. D. Del Gaizo, and A. Isaacson. Genicular Artery Embolization for the Treatment of Knee Pain Secondary to Osteoarthritis. Journal of vascular and interventional radiology 31:1096-1102, 2020.
4. Bagla, S., R. Piechowiak, A. Sajan, J. Orlando, T. Hartman, and A. Isaacson. Multicenter Randomized Sham Controlled Study of Genicular Artery Embolization for Knee Pain Secondary to Osteoarthritis. Journal of vascular and interventional radiology 33:2-10.e2, 2022.
5. Borowski, A. M., MD, A. Frangos MS, J. W. McCann MD, and D. B. Brown MD. Pressure Wire Assessment of Hemodynamic Alterations after Chemoembolization of Hepatocellular Carcinoma. Academic radiology 20:1037-1040, 2013.
6. Caine, M., MPhil, M. S. McCafferty BSc, S. McGhee MSc, P. Garcia PhD. W. M. Mullett PhD, X. Zhang PhD, M. Hill PhD, M. R. Dreher PhD, and A. L. Lewis PhD. Impact of Yttrium-90) Microsphere Density, Flow Dynamics, and Administration Technique on Spatial Distribution: Analysis Using an In Vitro Model. Journal of vascular and interventional radiology 28:260-268.e2, 2016.
7. Duffis, E. J., C. D. Gandhi. C. J. Prestigiacomo, T. Abruzzo, F. Albuquerque, K. R. Bulsara, C. P. Derdeyn, J. F. Fraser, J. A. Hirsch, M. S. Hussain, H. M. Do, M. V. Javaraman, P. M. Meyers, and S. Narayanan. Head, neck, and brain tumor embolization guidelines. Journal of NeuroInterventional Surgery 4:251-255, 2012.
8. Dutta, D., K. Lee, R. A. Allen. Y. Wang, J. C. Brigham, and K. Kim. Non-invasive Assessment of Elastic Modulus of Arterial Constructs during Cell Culture Using Ultrasound Elasticity Imaging. Ultrasound in medicine & biology 39:2103-2115 2013.
9. Fako, V. and X. W. Wang. The status of transarterial chemoembolization treatment in the era of precision oncology. Hepatic oncology 4:55-63, 2017.
10. Fontana, F., F. Piacentino, C. Ossola, A. Coppola, M. Curti, E. Macchi, G. De Marchi, C. Floridi, A. M. Ierardi, G. Carrafiello, S. Segato, G. Carcano, and M. Venturini. Transcatheter Arterial Embolization in Acute Non-Variceal Gastrointestinal Bleedings: A Ten-Year Single-Center Experience in 91 Patients and Review of the Literature. Journal of clinical medicine 10:4979, 2021.
11. Gowda, P. C., V. X. Chen, M. C. Sobral, T. L. Bobrow, T. G. Romer, A. K. Palepu, J. Y. Guo, D. J. Kim, A. S. Tsai, S. Chen, C. R. Weiss, and N. J. Durr. Establishing a Quantitative Endpoint for Transarterial Embolization From Real-Time Pressure Measurements. J. Med. Devices 15. 2021.
12. Gowda, P. C., K. Lobner, N. Hafezi-Nejad, and C. R. Weiss. Bibliometric analysis of interventional radiology studies in PubMed-indexed literature from 1991 to 2020. Clinical imaging 85:43-47, 2022.
13. Jernigan, S. R., MS, J. A. Osborne PhD, C. J. Mirek BS, and G. Buckner PhD. Selective Internal Radiation Therapy: Quantifying Distal Penetration and Distribution of Resin and Glass Microspheres in a Surrogate Arterial Model. Journal of vascular and interventional radiology 26:897-904.e2, 2015.
14. Kohn, J. C., M. C. Lampi, and C. A. Reinhart-King. Age-related vascular stiffening: causes and consequences. Frontiers in Genetics 6:112, 2015.
15. Kothary, N., MD., J. L. Weintraub MD, J. Susman MD, and J. H. Rundback MD. Transarterial Chemoembolization for Primary Hepatocellular Carcinoma in Patients at High Risk. Journal of vascular and interventional radiology 18:1517-1526, 2007.
16. Manyonda, I., A. Belli, M. Lumsden, J. Moss, W. Mckinnon, L. J. Middleton, V. Cheed, O. Wu, F. Sirkeci, J. P. Daniels, and K. McPherson. Uterine-Artery Embolization or Myomectomy for Uterine Fibroids. The New England journal of medicine 383:440-451. 2020.
17. Rose, S. C., K. H. Narsinh, A. J. Isaacson, A. M. Fischman, and J. Golzarian. The Beauty and Bane of Pressure-Directed Embolotherapy: Hemodynamic Principles and Preliminary Clinical Evidence. American journal of roentgenology (1976) 212:686-695, 2019.
18. Sajan. A., T. Mehta., P. Desai, A. Isaacson, and S. Bagla. Minimally Invasive Treatments for Benign Prostatic Hyperplasia: Systematic Review and Network Meta-Analysis. Journal of vascular and interventional radiology 33:359-367.e8, 2022.
19. Schwartz, J. S., J. N. Cohn, and R. J. Bache. Effects of coronary occlusion on flow in the distribution of a neighboring stenotic coronary artery in the dog. The American journal of cardiology 52:189-195, 1983.
20. Silveira, L. A. d., F. B. C. Silveira, and V. P. S. Fazan. Arterial diameter of the celiac trunk and its branches Anatomical study. Acta Cirurgica Brasileira 24:43-47, 2009.
21. Taebi, A., R. M. Pillai, B. S. Roudsari, C. T. Vu, and E. Roncali. Computational Modeling of the Liver Arterial Blood Flow for Microsphere Therapy: Effect of Boundary Conditions. Bioengineering (Basel) 7:64, 2020.
22. Topper. S. R., D. C. Levin, D. R. Hansberry, D. Guez, R. S. Winokur, R. D. Adamo, and D. J. Eschelman. Trends in Percutaneous Embolization Procedures by Radiologists and Other Specialists. Journal of vascular and interventional radiology 31:961-966, 2020.
23. Weiss, C. R., and C. R. Bailey. Bariatric Arterial Embolization: Are We There Yet? Journal of the American College of Cardiology 76:2318-2320, 2020.

1. An apparatus comprising:
a body defining an interior flow path, wherein the interior flow path comprises a portion of an artificial artery and at least one branch from the artificial artery, wherein the body comprises, in fluid communication with the interior flow path, at least one inlet and a main outlet, wherein each branch of the at least one branch from the artificial artery comprises a respective branch outlet, wherein the body comprises a plurality of outwardly extending conduits in fluid communication with, and spaced along, the interior flow path.

2. The apparatus of claim 1, wherein the artificial artery has dimensions representative of a celiac axis.

3. The apparatus of claim 1, wherein the body defines a respective tube fitting at each of the at least one inlet, the main outlet, and the respective branch outlet for each branch of the at least one branch from the artificial artery.

4. The apparatus of claim 3, wherein the respective tube fitting comprises a barb.

5. The apparatus of claim 1, wherein the body is 3D printed.

6. The apparatus of claim 1, further comprising, coupled to each outwardly extending conduit of the plurality of outwardly extending conduits, one of:
a respective plug: or
a respective sensor.

7. The apparatus of claim 6, wherein each respective sensor is a pressure sensor.

8. The apparatus of claim 1, further comprising a flow sensor in fluid communication with the main outlet and the respective branch outlet for each branch of the at least one branch from the artificial artery.

9. The apparatus of claim 1, wherein the body is transparent or translucent.

10. The apparatus of claim 1, further comprising a fluid supply in fluid communication with the at least one inlet.

11. The apparatus of claim 1, wherein the at least one branch from the artificial artery comprises three branches.

12. The apparatus of claim 1, wherein the at least one inlet consists of a single inlet.

13. The apparatus of claim 1, wherein the at least one inlet comprises two inlets.

14. The apparatus of claim 1, wherein the plurality of outwardly extending conduits extend perpendicularly or generally perpendicularly to the interior flow path.

15. A method of using the apparatus as in claim 1, the method comprising:
flowing a fluid into the at least one inlet of the body:
injecting an embolic agent into the flow path at an embolization site: and
measuring flow through at least one of:
the main outlet: or
the respective branch outlet for each branch of the at least one branch.

16. The method of claim 15, further comprising measuring at least one pressure at at least one outwardly extending conduit of the plurality of outwardly extending conduits.

17. The method of claim 15, wherein the fluid comprises a dye, wherein the dye is configured to emulate angiographic imaging.

18. The method of claim 15, further comprising collecting, at a branch of the at least one branch that is upstream of the embolization site, the embolic agent.

19. The method of claim 18, wherein catching the embolic agent comprises catching the embolic agent in a mesh.

20. The method of claim 15, wherein the at least one inlet comprises a first inlet and a second inlet, wherein flowing the fluid into the at least one inlet comprises flowing the fluid into the first inlet, the method comprising, prior to injecting the embolic agent into the flow path at the embolization site, inserting a catheter into the second inlet, wherein injecting the embolic agent into the flow path at the embolization site comprises injecting the embolic agent through the catheter.
